(19) United States
(12) Patent Application Publication
(10) Pub. No.: US 2008/0245054 A1
(43) Pub. Date: Oct. 9, 2008

(54) Cooling System for an Aircraft, Aircraft Comprising the Cooling System and Cooling Method

(75) Inventors: Hans Martensson, Trollhattan (SE); Anders Hellgren, Trollhattan (SE)

Correspondence Address: WRB-IP LLP, 1217 KING STREET, ALEXANDRIA, VA, 22314, US

(73) Assignee: VOLVO AERO CORPORATION, Trollhättan (SE)

(21) Appl. No.: 12/065,513

(22) PCT Filed: Sep. 20, 2005
(86) PCT No.: PCT/SE2005/001385

§ 371 Date: Mar. 3, 2008

(51) Int. Cl. F02K 11/00

(52) U.S. Cl. 60/267

(57) ABSTRACT

A cooling system for an aircraft includes a cooling circuit for transporting a coolant, with the cooling circuit running to a component in the aircraft that is heated up during flying in order to take up heat from the heated-up component via the coolant. The cooling circuit runs to a jet engine for propulsion of the aircraft in order to release heat to a flow of gas in the jet engine via the coolant.

### BACKGROUND AND SUMMARY

The present invention relates to a cooling system for an aircraft, comprising a cooling circuit for transportation of a coolant, with the cooling circuit running to a component in the aircraft that becomes heated during flying in order to take up heat from the heated-up component via the coolant.

The invention also relates to a cooling method for an aircraft and an aircraft comprising the cooling system.

Protecting an aircraft against an attack by giving the aircraft a low so-called signature is already known. By signature is meant, in this context, the contrast against the background. An aircraft should, for example, have a low signature with regard to infrared radiation (IR). Hot structures and hot exhaust gases give rise to an IR signature. External projecting surfaces or edges on the fuselage or wings of the aircraft can become hot during flying as a result of aerodynamic friction and can then give rise to an IR signature. Examples of such surfaces are a leading edge of an aircraft's wing and a vertical tailfin and/or rudder found on certain types of aircraft. Similarly, metallic surfaces in the jet engine can give rise to an IR signature during operation of the jet engine.

The cooling system is designed to suppress infrared radiation from the aircraft.

U.S. Pat. No. 6,435,454 describes a cooling system for suppressing infrared radiation from an aircraft with the object of camouflaging the aircraft and avoiding detection. A surface on the aircraft, such as an under part of the fuselage or wing, is cooled by the cooling system and the heat that has been taken up is released to the aircraft's fuel. The cooling system utilizes thermal tubes, as used on satellites, as heat exchangers on the said surface.

According to the cooling system in U.S. Pat. No. 6,435,454, there is thus a transfer of heat from the heated-up coolant to the fuel, which fuel is then used in the combustion process in the jet engine to create thrust. This results in additional costs, for example, due to the fact that the fuel tanks must/should be insulated and there should be systems for monitoring the fuel temperature. In addition, the cooling capacity of the fuel is limited. The cooling capacity of the fuel can also be required for other purposes, such as for internal cooling processes in the engine, cooling of sensors, etc., which further reduces the cooling capacity of the fuel that is available for the signature reduction.

It is desirable to reduce the infrared radiation given off from the aircraft during flying, in order to make possible an effective signature reduction and to solve the abovementioned problems.

According to an aspect of the present invention, a cooling system for an aircraft comprises a cooling circuit for transportation of a coolant, with the cooling circuit running to a component in the aircraft that is heated up during flying in order to take up heat from the heated-up component via the coolant, with the cooling circuit running to a jet engine for propulsion of the aircraft in order to release heat to a flow of gas in the jet engine via the coolant.

This cooling system makes it possible to use fewer components and as a result to achieve a lower total weight than previously-known solutions. This in itself results in a signature reduction, as lower thrust is required. In addition, it is possible to cool components/structures continuously without needing to monitor whether the fuel temperature is becoming too high.

According to a method for cooling a component in an aircraft that is heated up during flying, a coolant, that has a temperature that is essentially lower than the temperature of the heated-up component, is transported to the heated-up component, heat is taken up from the heated-up component via the coolant, in which the temperature in the exhaust gases from a jet engine for propulsion of the aircraft is increased, which increase corresponds to the energy that is generated during the taking up of heat from the heated-up component.

It can be said that the temperature of a structure (and hence the IR radiation from the structure) is reduced and the heat is transferred to increase the temperature of a gas. Structural radiation is thus converted to gas radiation.

The exhaust gases from the jet engines emit IR radiation in a more advantageous way than a heated-up solid surface or structure in the aircraft. The various gas components in the air only emit radiation at certain specific wavelengths and these wavelengths are absorbed efficiently by the surrounding atmosphere. Hot surfaces or structures, on the other hand, emit radiation within a wide range of wavelengths and the radiation is only partially absorbed by the atmosphere, which means that this radiation tends to be strong, even at long distances.

According to a preferred embodiment of the method, the coolant is taken to the jet engine for releasing heat to a flow of gas in the jet engine. This results in a direct transmission, or transfer, of the infrared radiation from the component that is less advantageous, as far as detection is concerned, to the more advantageous exhaust gases.

According to an alternative to the previous embodiment, ram air is taken in and utilized as the coolant for transportation to the heated-up component. After cooling of the component, the ram air passes out into the atmosphere. This principle results in an increased total resistance for the aircraft, that must be compensated for by a higher thrust. This increased thrust results in increased exhaust gas temperatures and thus an increase in the gas radiation. A turbine is suitably used to reduce the temperature (the stagnation temperature) of the air.

Additional preferred embodiments and advantages associated with these are apparent from the following description, drawings and claims.

### BRIEF DESCRIPTION OF DRAWINGS

The invention is described in greater detail in the following, with reference to the embodiments that are shown in the attached drawings, in which

FIG. 1 shows an aircraft 1 in a perspective view from below,

FIG. 2 shows schematically an aircraft engine in a cross-sectional view,

FIG. 3 shows an outline diagram of a cooling system for the aircraft according to a first embodiment.

### DETAILED DESCRIPTION

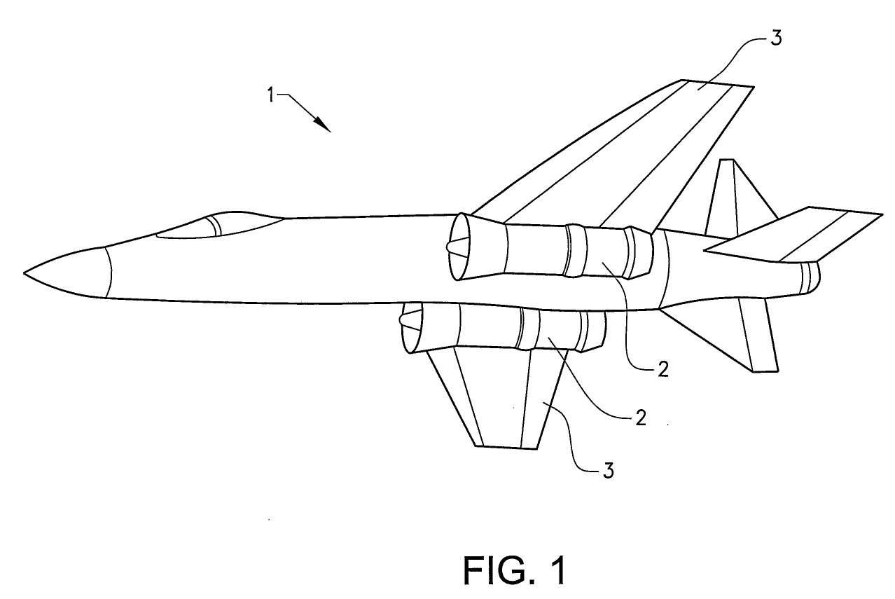

FIG. 1 shows an aircraft 1 in a perspective view from below. A jet engine 2 is mounted under each wing 3.

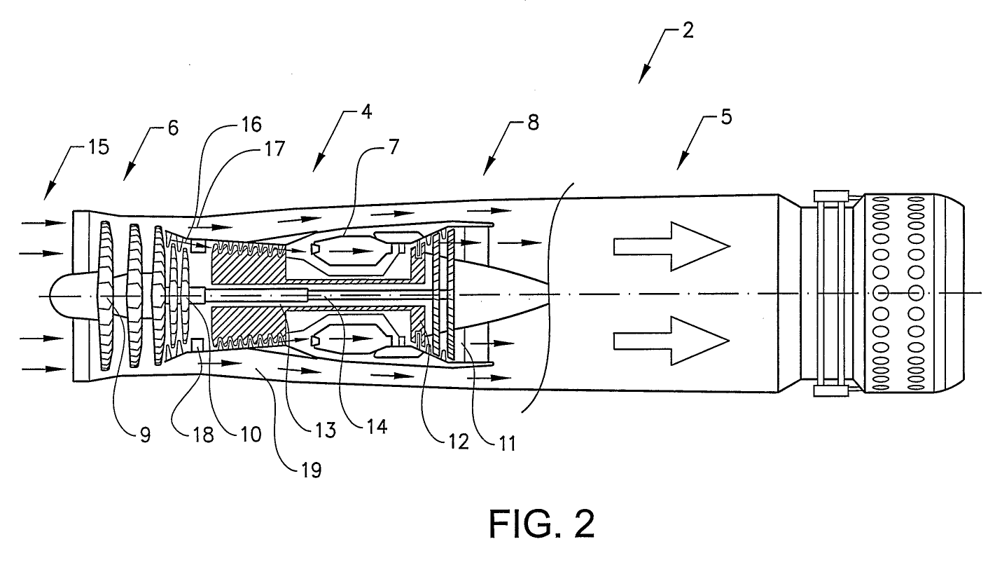

FIG. 2 shows one of the jet engines 2 in a cross-sectional view. The jet engine 2 comprises two main parts, a gas generator 4 and an afterburner 5. The gas generator 4 is of the double-flow type and has twin rotors.

The jet engine comprises a compressor section 6 for compression of the incoming air, a combustion chamber 7 for combustion of the compressed air and a turbine section 8 arranged after the combustion chamber, which turbine section is connected to the compressor section in such a way that it can rotate in order to drive this by means of the energy-rich gases from the combustion chamber. The compressor section 6 comprises a low-pressure part 9, or fan, and a high-pressure part 10. The turbine section 8 comprises a low-pressure part 11 and a high-pressure part 12. The high-pressure compressor 10 is attached to the high-pressure turbine 12 via a first shaft 13 in such a way that it can rotate and the low-pressure compressor 9 is attached to the low-pressure turbine 11 via a second shaft 14 in such a way that it can rotate. In this way, a high-pressure rotor and a low-pressure rotor are created. These are mounted concentrically and can rotate freely in relation to each other.

As mentioned, the gas generator 4 is of the double-flow type, which means that an incoming air flow 15 is divided up into two flows after it has passed through the fan 9; an inner flow 16, the compressor air flow, and an outer flow 17, the fan air flow. The gas generator 4 therefore comprises a radially internal main duct 18 for the primary flow to the combustion chamber 7 and a radially external duct 19 for the secondary flow (bypass for the fan air). The gas ducts 18, 19 are concentric and circular.

Downstream of the low-pressure turbine 11, the inner hot gas flow is combined with the outer cold fan air flow.

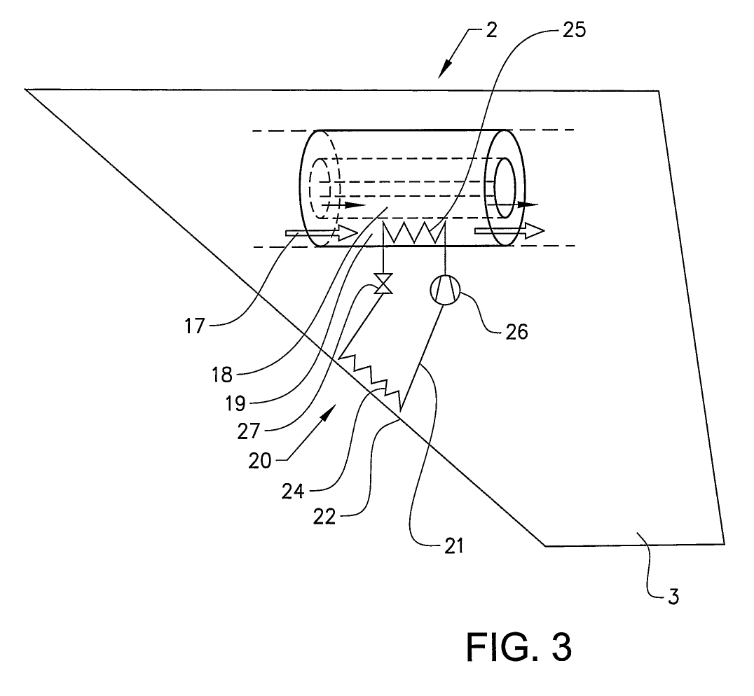

FIG. 3 shows an outline drawing of a cooling system 20 for the aircraft 1. The cooling system 20 comprises a cooling circuit 21 for transportation of a coolant. The cooling circuit 21 runs to a component 22 in the aircraft that is heated up during flying in order to take up heat from the heated-up component 22 via the coolant. The component 22 comprises preferably a structural part of the aircraft. The component 22 thus comprises a structural part that has an increase in temperature when it is subjected to a thermal load during operation of the aircraft. It is primarily an external surface of the structural part 22 that is heated up. In the example illustrated, the component 22 comprises a leading edge of one of the wings 3. The leading edge of the wing 3 is heated up during flying due to aerodynamic friction.

A first section 24 of the cooling circuit runs along a part of the leading edge 22 of the wing 3. Heat is transferred to the coolant in this first section 24 of the cooling circuit 21 that is adjacent to the leading edge 22 of the wing 3. The cooling circuit 21 runs through the structural component 22, that is inside the wing 3. The cooling circuit 21 thus runs into and out of the structural component 22. There is accordingly a transfer of heat from the hot air inside the wing 3 at its leading edge 22 to the coolant.

The cooling circuit 21 continues on to the jet engine 2 in order to release heat to a flow of gas in the form of the secondary flow 17 in the outer duct 19 via the coolant. A second section 25 of the cooling circuit 21 runs along a part of the duct 19 for the secondary flow. The cooling circuit 21 thus runs inside the duct 19 for the secondary flow in such a way that there is a transfer of heat from the coolant to the secondary flow. Accordingly, the cooling circuit 21 passes into and out of the duct 19.

The cooling circuit 21 comprises pipes or other means for transporting the coolant from the heated-up component 22 to the jet engine 2. The cooling circuit 21 forms here a closed circuit.

The cooling system 20 forms a refrigeration apparatus of the compressor type, similar to a refrigerator or a heat pump. The coolant thus comprises a phase-transforming medium for generating cold in the heated-up component 22. The said phase-transforming medium is of such a composition that it vaporizes in the vicinity of the heated-up component and condenses in the vicinity of the jet engine 2. The phase-transforming medium (the working fluid) thus boils during the transmission of heat in the first section 24 of the cooling circuit 21.

The cooling system 20 comprises a compressor 26 arranged to draw away the vapor that is created during the vaporization. The compressor 26 transports the mass flow of the coolant around the closed circuit and at the same time maintains a high pressure in the condenser, that is in the closed section 25 of the cooling circuit 21.

The coolant can comprise a liquid, such as water, freon or the like.

The cooling system comprises, in addition, a regulator 27 arranged to regulate the mass flow and to maintain a required difference in pressure between the condenser 25 and the vaporizer 24.

As an alternative, a non-phase-transforming refrigeration apparatus is used, for example utilizing a Stirling cycle, in which a gas (air) is utilized.

According to an alternative embodiment of the cooling system, this comprises means for cooling the coolant in the form of a turbine arranged for expansion of the ram air. The turbine is then arranged in association with the air intake duct of the engine or the engine inlet. The turbine takes the high power that is in the ram air, when this passes through an intake duct and on into the engine, and converts the power of the air into turbine shaft power and at the same time lowers the overall temperature of the air. When the air velocity has been reduced, it can ideally have the same temperature as the surrounding atmosphere. Thereafter, the air can be taken directly to critical components for cooling of these. This principle results in a larger total resistance for the aircraft, that must be compensated for by a higher thrust. This increased thrust results in increased exhaust gas temperatures and thus an increase in the gas radiation, as described above.

According to the alternative embodiment, the coolant thus comprises the ram air. The cooling circuit then forms an open loop with a continual intake of ram air. This can be carried out efficiently when flying at high speed, that is at speeds higher than Mach 1, and at high altitudes where the surrounding air is cold.

As an alternative to a transfer of heat from the coolant to the fan air in the engine, there can be a transfer of heat from the coolant to the compressor air or ram air.

In addition, the amount of heat that is taken up from the heated-up component can be continuously regulated, taking into account the flying conditions.

The term “jet engine” utilized above is intended to include various types of engines that take in air at a relatively low speed, heat it up by combustion and eject it at a much higher speed. The concepts comprised in the term jet engine are, for example, turbojet engines and turbofan engines.

The invention is not to be considered to be limited to the embodiments described above, a number of additional variants and modifications being possible within the framework of the following claims.

As an alternative to cooling a heated-up structural part, such as a wing, the component can comprise a power-consuming apparatus, such as an electrical apparatus or an electronic component, such as avionics, radar or sensors. It is thus within the framework of the invention that the component is heated up during operation of the aircraft/engine and not necessarily by aerodynamic friction.

The invention can, of course, be utilized for other types of aircraft than the one illustrated in FIG. 1. The aircraft's jet engine can, for example, be positioned centrally in the fuselage of the aircraft.

The jet engine illustrated in FIG. 2 is only to be regarded as an exemplifying application of the invention. The invention can, of course, be used with a jet engine without afterburner.

1. A cooling system for an aircraft comprising a cooling circuit for transporting a coolant, with the cooling circuit running to a component in the aircraft that is heated up during flying, in order to take up heat from the heated-up component via the coolant, wherein the cooling circuit runs to a jet engine for propulsion of the aircraft in order to release heat to a flow of gas in the jet engine via the coolant.

2. The cooling system as claimed in claim 1, wherein the cooling circuit runs to a duct in the jet engine, which duct is intended for a secondary flow.

3. The cooling system as claimed in claim 1, wherein the cooling circuit runs to a duct for fan air in the jet engine.

4. The cooling system as claimed in claim 1, wherein the coolant consists of a phase-transforming medium.

5. The cooling system as claimed in claim 4, wherein the phase-transforming medium is of such a composition that it is vaporized in the vicinity of the heated-up component.

6. The cooling system as claimed in claim 4, wherein the phase-transforming medium is of such a composition that it is condensed in the vicinity of the jet engine 2.

7. The cooling system as claimed in claim 1, wherein the heated-up component comprises a structural part that is heated up by aerodynamic friction during flying.

8. The cooling system as claimed in claim 1, wherein the heated-up component comprises a leading edge of the wing of an aircraft.

9. The cooling system as claimed in claim 1, wherein the heated-up component comprises a power-consuming apparatus.

10. The cooling system as claimed in claim 1, wherein the heated-up component comprises an electronic component.

11. An aircraft comprising a jet engine for propulsion and a cooling system as claimed in any one of the preceding claims.

12. A method for cooling of a component in an aircraft that is heated up during flying, comprising
transporting a coolant that has a temperature that is lower than a temperature of the heated-up component to the heated-up component,
taking up heat from the heated-up component via the coolant, and
increasing a temperature of exhaust gases from a jet engine for propulsion of the aircraft in an amount corresponding to an amount of energy that is generated by the taking up of heat from the heated-up component.

13. The method as claimed in claim 12, wherein the coolant is cooled before it is transported to the heated-up component.

14. The method as claimed in claim 12, wherein the energy generated during the taking up of heat is transferred to the jet engine.

15. The method as claimed in claim 12, wherein the coolant is taken to the jet engine in order to release heat to a flow of gas in the jet engine.

16. The method as claimed in claim 12, wherein the coolant is taken to a duct in the jet engine, which duct is intended for a secondary flow.

17. The method as claimed in claim 12, wherein the coolant is taken to a duct for fan air in the jet engine.

18. The method as claimed in claim 12, wherein the coolant is transported in a closed circuit between the heated-up component and the jet engine.

19. The method as claimed in claim 12, wherein the coolant comprises a phase-transforming medium.

20. The cooling system as claimed in claim 19, wherein the phase-transforming medium is vaporized in the vicinity of the heated-up component.

21. The cooling system as claimed in claim 19, wherein the phase-transforming medium is condensed in the vicinity of the jet engine.

22. The method as claimed in claim 12, wherein ram air is taken in and utilized as coolant.

23. The method as claimed in claim 22, wherein the ram air is expanded before it is taken to the heated-up component.

24. The method as claimed in claim 12, wherein the quantity of heat that is taken up from the heated-up component is continuously regulated with regard to the flying conditions.

25. The method as claimed in claim 12, wherein the component that is heated up during flying comprises a structural part of the aircraft that is heated up by aerodynamic friction by contact with the air.

26. The method as claimed in claim 12, wherein the component that is heated up during flying comprises a power-consuming apparatus that is heated up during operation of the aircraft.
